(19) United States
(12) Patent Application Publication
(10) Pub. No.: US 2024/0294119 A1
(43) Pub. Date: Sep. 5, 2024

(54) TILTING MECHANISM

(71) Applicant: Thule Sweden AB, Hillerstorp (SE)

(72) Inventors: Lucas LUND, Norrahammar (SE); Anders NILVIUS, Värnamo (SE)

(21) Appl. No.: 18/576,657

(22) PCT Filed: Jul. 4, 2022
(86) PCT No.: PCT/EP2022/068440

§ 371 Date: Jan. 4, 2024

(30) Foreign Application Priority Data
Jul. 6, 2021 (EP) 21183970.9

(51) Int. Cl. B60R 9/055; E05F 1/12; E05F 5/02

(52) U.S. Cl. CPC B60R 9/055; E05F 1/1246; E05F 5/02; E05Y 2201/264; E05Y 2201/266; E05Y 2201/71

(57) ABSTRACT

Disclosed is a tilting mechanism for a load carrier. The tilting mechanism may be configured to assist a pivoting movement of the movable portion of the load carrier at least into a non-use position of the movable portion. The tilting mechanism may comprise a first coupling portion configured to be coupled to the movable portion of the load carrier and movable between a retracted position and an extended position. Furthermore, the tilting mechanism may comprise a dampening mechanism which is configured to at least partially decelerate or limit a movement speed of the first coupling portion upon moving the same to the extended position.

### TECHNICAL FIELD

The present disclosure relates to a tilting mechanism for a load carrier, as well as to load carriers comprising such a tilting mechanism.

### BACKGROUND

Conventional load carriers sometimes comprise tilting mechanisms which allow moving the movable portion thereof with respect to a stationary portion. For example cargo boxes are known which comprise an openable and closable lid which is pivotably movable with respect to the base portion. Furthermore, load carriers mountable to the rear of a vehicle are known in which a platform for supporting goods to be transported may be tilted for allowing access to a trunk of a vehicle.

Movement of the above-described movable portions is primarily effected by a force applied by a user and may be assisted by specific force application configurations. However, known systems are configured such that the movable portion is set into vibration when it reaches an extended position which may lead to damages.

### SUMMARY

Therefore, there exists a desire for an improved tilting mechanism addressing the above-mentioned drawback. In particular, there is a desire to improve the movement of the movable portion such that a vibration of the movable portion at the extended position is at least reduced or even fully prevented.

In view of the above, it is the object of the invention to provide an improved tilting mechanism for a load carrier.

The object is solved by a tilting mechanism according to claim 1. Advantageous further formations are subject of the dependent claims.

Disclosed is a tilting mechanism for a load carrier. The tilting mechanism is configured to assist a tilting movement of a movable portion of the load carrier at least into a non-use position of the movable portion. The non-use position of the movable portion may be a position in which the load carrier is normally not usable. For example, a non-use position may be a position of the movable portion which allows a loading of the load carrier, or which grants access to certain portions of a vehicle on which the load carrier is mounted, for example to the trunk of the vehicle. The movable portion may be a lid for covering the base portion of a load carrier. The movable portion may be a platform for supporting goods to be transported.

The tilting mechanism comprises a first coupling portion which is configured to be coupled to the movable portion of the load carrier. For example, the first coupling portion may be configured such that a pivotable connection between the movable portion and the first coupling portion may be established. The first coupling portion may be configured such that it may be hingedly coupled to the movable portion. For example, the first coupling portion may comprise an opening for accommodating a pivot member, for example a pivot pin or pivot bolt, therein. The pivot member may be coupled rotatably with respect to the coupling portion and/or the movable portion.

The first coupling portion is configured to be movable between a retracted position and an extended position. The extended position corresponds to a position of the first coupling portion, in which the movable portion is in the non-use position. The retracted position may correspond to a position in which the movable portion is in a use position.

The tilting mechanism further comprises damping mechanism. The damping mechanism is configured to at least partially decelerate or limit a movement speed of the first coupling portion up on moving the same to the extended position. With such a configuration, the first coupling portion may be decelerated, or its movement speed may be limited during its movement to the extended position. In this way, it is prevented that the first coupling portion is stopped too abruptly thereby preventing the generation of a vibrating and/or wobbling movement of the movable portion.

According to an embodiment, the tilting mechanism may further comprise a second coupling portion. The second coupling portion may be configured to be coupled to a stationary portion of the load carrier. Such a stationary portion may for example be a base portion of a roof box or may be a supporting frame fixedly coupled to the rear of the vehicle. The second coupling portion may be operatively coupled to the first coupling portion by means of an operative coupling. The operative coupling may be a kinematic chain. The kinematic chain may comprise one rigid member on which the first portion and the second portion are provided or may comprise multiple rigid members coupled to each other by means of joints. The second coupling portion may be operatively coupled to the first coupling portion such that the first coupling portion is movable with respect to the second coupling portion along a path having a translator three directional component and/or a rotator a directional component. The operative coupling may be configured such that the first coupling portion is translatory movable with respect to the second coupling portion. The operative coupling may be configured such that the first coupling portion is rotatably movable with respect to the second coupling portion. For example, the first coupling portion may be arranged pivotably movable about the second coupling portion. The kinematic chain may comprise two link members pivotably coupled to each other. The link members may also be referred to as arms. In an embodiment, the link members are pivotably coupled to each other at a first end portion thereof. At opposite end portions, the link members may be coupled to or may comprise the first coupling portion and the second coupling portion, respectively. The link members may be elongate rigid bodies.

According to an embodiment, the dampening mechanism may be configured to act on the operative coupling between the first coupling portion and the second coupling portion such that it provides a resistance against the movement of the first coupling portion relative to the second coupling portion at least during movement of the first coupling portion in extension direction. According to the present disclosure, the extension direction is to be understood as a direction in which the first coupling portion moves towards the extended position. A retraction direction may be understood as a direction in which the first coupling member moves towards their retracted position. Accordingly, the first coupling portion may be configured movable against a resistance provided by the dampening mechanism. The dampening mechanism may be configured to provide a resistance force in opposite direction of the travel direction of the first coupling portion. The dampening mechanism may be configured such that it provides a resistance only when said first coupling portion is moved in extension direction. Accordingly, only a movement towards the extended position may be controlled by the dampening mechanism whereas a movement in retraction direction is not influenced by the dampening mechanism. In an embodiment, the dampening mechanism may be configured to act on the movement of the first coupling portion in both directions.

The dampening mechanism may comprise a linear damper. The dampening mechanism may comprise a rotary damper. In an embodiment, the dampening mechanism may comprise a linear damper and a rotary damper.

In an embodiment, the resistance exerted by the dampening mechanism may be adjustable. In some embodiments, the dampening mechanism may be configured to provide a continuous dampening on the movement of the first coupling portion. Accordingly, the dampening mechanism may be configured to be permanently operatively coupled to the first coupling portion. The dampening mechanism may alternatively be configured such that it is only temporarily operatively coupled to the first coupling portion. For example, the dampening mechanism may be configured such that it only acts on the operative coupling between the first coupling portion and the second coupling portion in a specific region of the movement path of the first coupling portion, for example in a region in which the first coupling portion is positioned near the extended position. In such a configuration, the first coupling portion may first move without being controlled by the damping mechanism and may then reach a region in which it is controlled by the damping mechanism during further movement.

In an embodiment, the tilting mechanism may further comprise an urging mechanism. The urging mechanism may act on the operative coupling between the first coupling portion and the second coupling portion such that it at least partially applies a force which urges the first coupling portion with respect to the second coupling portion at least in extension direction of the first coupling portion. Accordingly, the urging mechanism may apply a force urging the first coupling portion in extension direction. Such a configuration may provide an assisting force for moving the movable portion to which the first coupling portion is coupled. In this way, a user may be assisted in moving the movable portion.

In an embodiment, the urging mechanism may act on the operative coupling between the first coupling portion and the second coupling portion such that it at least partially applies a force which urges the first coupling portion with respect to the second coupling portion in retraction direction of the first coupling portion. Accordingly, the urging mechanism may apply a force urging the first coupling portion in retraction direction. Such a configuration may provide an assisting force for moving the movable portion in a direction towards the use position. It is noted that an urging mechanism may be provided which applies a force in extension direction and in retraction direction. A configuration of such an urging mechanism may be such that the direction of the applied force changes at a predetermined position of the first coupling portion.

The urging mechanism may also be referred to as force application mechanism. The urging mechanism or force application mechanism may comprise a force application member. The urging mechanism may comprise a biasing member, for example a spring such as a metal spring or a gas spring. The force application member may be prebiased, for example by the biasing member. The force application member may be configured to act on a force receiving surface, for example a cam surface, to generate a moment for moving the first coupling portion with respect to the second coupling portion. The cam surface may be integrally formed in an arm or link member on which the first coupling portion is provided. The force application member may be provided in an arm or link member on which the second coupling portion is provided. The force application member may comprise an accommodating portion for receiving the biasing member, for example a recess. The accommodating portion may be configured to receive an end portion of the biasing member therein. In addition or alternatively, the accommodating portion may be configured to at least partially receive members of the dampening mechanism. For example, the biasing member may be a coil spring and the dampening mechanism may comprise a linear damper which may be accommodated in the coil spring such that the coil spring surrounds the linear damper. An end portion of the linear damper may be coupled to the force application member. The force application member may be configured movable linearly towards and away from the second coupling portion.

The dampening mechanism may be operatively coupled to the force application member and may be configured to at least partially decelerate or limit a movement speed of the force application member. In addition or alternatively, the force application member may be configured translatory movable. In addition or alternatively, the dampening mechanism may comprise a linear damper, for example a frictional damper, or a viscous damper such as a dashpot, or a pneumatic cylinder, for example a vacuum chamber with a piston. The dampening mechanism may be accommodated in the force application member.

In addition or alternatively, the dampening mechanism may comprise a rotary damper, for example a frictional damper or the viscous damper. The rotary damper may be operatively coupled to the force application member by means of the gear mechanism. The rotary damper may be operatively coupled to the force application member by means of a cog which is engaged with a toothed portion on the force application member.

In an embodiment, the tilting mechanism further comprises a hinge mechanism defining the operative coupling. The hinge mechanism may comprise a pivotable first link member and a pivotable second link member coupled to each other pivotable about a pivot axis. The second link member may be movable relative to the first link member between a retracted position and an extended position. The first coupling portion may be provided on the second link member and the second coupling portion may be provided on the first link member.

The dampening mechanism may be operatively coupled to the first link member and the second link member. The dampening mechanism may comprise a linear damper operatively coupled to the first link member at a first coupling section thereof and operatively coupled to the second link member at a second coupling section thereof.

The dampening mechanism may in addition or alternatively comprise a rotary damper having a housing operatively coupled, for example integrally movably coupled, to the first link member or the second link member, and a rotary shaft, for example a rotary piston, operatively coupled to the other one of the second link member and the first link member. The rotary shaft may be configured such that it forms a pivot pin defining the pivot axis.

Disclosed is further a lid lifter for a load carrier. The lid lifter may be configured to couple an openable and closable lid on a base portion of the load carrier. The lid lifter may comprise a tilting mechanism comprising one or more of the features as described before. The first coupling portion may be configured pivotably couplable to the lid.

Disclosed is further a cargo box. The cargo box may be a roof box or a rear box. The cargo box may be mountable on a vehicle. The cargo box may comprise a base portion for supporting goods to be transported. Furthermore, the cargo box may comprise an openable and closable lid which is pivotably mounted on the base portion so as to be movable between a closed position and an opened position. The cargo box may further comprise a lid lifter as described before. The lid lifter may be coupled to the lid by means of the first coupling portion and may be coupled to the base portion by means of the second coupling portion.

The cargo box may be configured collapsible. For example, the cargo box may comprise a collapsible lid and/or collapsible base portion which is/are transferable between a collapsed configuration in which a volume of the lid and/or base portion is reduced and a deployed configuration in which a volume of the lid and/or base portion is enlarged.

Disclosed is further a load carrier for a vehicle. The load carrier may be a rear mounted load carrier. The load carrier may be a bike carrier. The load carrier may comprise a base couplable to the vehicle and a movable portion, for example a platform for supporting goods to be transported, which is pivotably coupled to the base so as to be movable between a use configuration in which the movable portion is folded onto the base, and a non-use configuration in which the movable portion is tilted with respect to the base. The load carrier may further comprise a tilting mechanism which is configured with one or more features as described before, wherein the first coupling portion may be coupled to the movable portion and the second coupling portion may be coupled to the stationary portion.

Additional features and advantages may be gleaned by the person skilled in the art from the following description of exemplary embodiments and the attached drawings.

### BRIEF DESCRIPTION OF THE DRAWINGS

The present disclosure will hereinafter be described in conjunction with the following Figures, wherein like numerals denote like elements. The drawings, which are incorporated herein and form part of the specification, illustrate embodiments and, together with the description, further serve to explain the principles of the embodiments and to enable a person skilled in the art to make and use the embodiments.

FIG. 1 shows a perspective view of a load carrier comprising a tilting mechanism according to an embodiment.

FIG. 2 shows a perspective view of a tilting mechanism according to an embodiment in a retracted configuration.

FIG. 3 shows a side view of the tilting mechanism of FIG. 2 in an extended configuration.

FIG. 4 shows a sectional side view of a tilting mechanism according to a further embodiment in a retracted configuration.

FIG. 5 shows the tilting mechanism as shown in FIG. 4 in an extended configuration.

FIG. 6 shows a perspective view of a tilting mechanism according to a further embodiment.

FIG. 7 shows a perspective view of a tilting mechanism according to another embodiment.

FIG. 8 shows a side view of a tilting mechanism according to a further embodiment.

FIG. 9 shows an enlarged perspective view of a portion of the tilting mechanism of FIG. 8.

FIG. 10 shows a side view of a tilting mechanism according to a further embodiment.

FIG. 11 shows an enlarged perspective view of a portion of the tilting mechanism of FIG. 10.

FIG. 12 shows a side view of a tilting mechanism according to a further embodiment.

FIG. 13 shows a sectional view of an enlarged portion of the tilting mechanism of FIG. 12.

FIG. 14 shows a sectional perspective view of a tilting mechanism according to a further embodiment.

FIGS. 15 and 16 show details of a dampening mechanism as used in the embodiment as shown in FIG. 14.

FIG. 17 shows a cargo box according to an embodiment.

FIG. 18 shows a sectional side view of the cargo box of FIG. 17.

FIG. 19 shows a bike carrier according to an embodiment.

FIG. 20 shows a collapsible cargo box according to an embodiment.

All figures are only schematic depictions of exemplary embodiments in which, in particular, distances and dimensional correlations are not presented to scale.

### DETAILED DESCRIPTION OF EMBODIMENTS

The following detailed description is merely exemplary in nature and is not intended to limit application and uses. Furthermore, there is no intention to be bound by any theory presented in the preceding background or summary or the following detailed description.

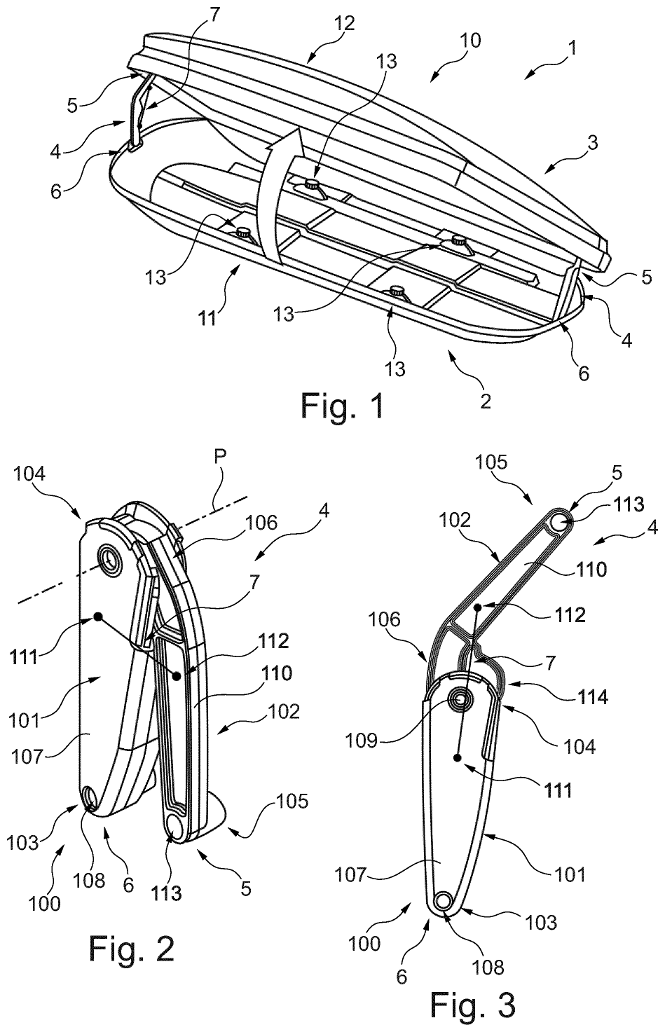

FIG. 1 shows a load carrier 1 in a perspective view. The load carrier 1 comprises a movable portion 3 which is pivotably coupled to a stationary portion 2 by means of tilting mechanisms 4. The load carrier 1 may be configured as a cargo box, for example a roof box 10 which is mountable on the roof of a vehicle. The roof box 10 comprises an elongate shape and extends in longitudinal direction of the vehicle when the same is mounted on the vehicle. The roof box 10 comprises a base portion 11 defining a stationary portion 2 of the load carrier 1 and an openable and closable lid 12 defining a movable portion 3 of the load carrier 1. The lid 12 is hingedly coupled to a lateral portion of the roof box 10. The roof box 10 comprises optional fixation units 13 provided on the base portion 11 and configured to fixedly engage with a rack system provided on the vehicle. For example, the fixation units 13 may be configured as clamping members which may be brought in clamping engagement with crossbars of the rack system thereby fixedly attaching the roof box 10 on the rack system. In FIG. 1, the lid 12 is shown in an opened configuration in which it is moved to an opened position. At a front portion of the roof box 10 and a rear portion of the roof box 10, a tilting mechanism 4 is provided. Each tilting mechanism 4 comprises a first coupling portion 5 which is pivotably coupled to the lid 12. Each tilting mechanism 4 comprises a second coupling portion 6 which is pivotably mounted on the base portion 11. Accordingly, when moving the lid 12 between a closed configuration and the opened configuration, the first coupling portion 5 is moved relative to the second coupling portion 6 towards and away from the same. For example, the first coupling portion 5 is moved relative to the second coupling portion 6 between a retracted position and an extended position. The retracted position of the first coupling portion 5 corresponds to a position of the same at which the lid 12 is in the closed position. The extended position of the first coupling portion 5 corresponds to a position of the same at which the lid 12 is in the opened position. Each tilting mechanism 4 may further comprise a dampening mechanism 7 which is configured to at least partially decelerate or limit a movement speed of the first coupling portion 5 upon moving the same to the extended position. The second coupling portion 6 is operatively coupled to the first coupling portion by means of an operative coupling. The operative coupling may be a kinematic chain. The first coupling portion 5 is held movable with respect to the second coupling portion 6 along a path having a translatory directional component and a rotatably directional component.

The dampening mechanism 7 may be configured to act on the operative coupling between the first coupling portion 5 and the second coupling portion 6 such that it provides a resistance against the movement of the first coupling portion 5 with respect to the second coupling portion 6. In the present configuration, the dampening mechanism 7 may be configured to provide a resistance against the movement of the first coupling portion 5 at least in extension direction of the first coupling portion 5. In particular, the dampening mechanism 7 may be configured to provide such a resistance only against a movement of the first coupling portion 5 in extension direction. In this way, a configuration may be provided in which the dampening mechanism 7 acts on the movement of the first coupling portion 5 during a movement of the movable member 3 towards a non-use position, which in the present configuration corresponds to a movement of the lid 12 towards the opened position. In this way, the speed of the lid 12 in an opening direction may be controlled, in particular such that a predetermined speed is not exceeded so that when the first coupling portion 5 stops at its extended position, substantially no shock is created on the lid 12 thereby preventing or at least reducing undesired vibrations or a wobbling movement of the lid.

In a modification, a resistance may also be provided against the movement of the first coupling portion 5 in retraction direction of the first coupling portion 5. In this way, a soft closing of the lid 12 may be achieved. It is noted that the dampening mechanism 7 may in some embodiments be configured to continuously apply a resistance. In other words, the dampening mechanism 7 may be provided in the tilting mechanism 4 such that a resistance is applied over the entire movement of the first coupling portion 5.

In some modifications, the dampening mechanism 7 may be configured to apply such resistance only in a specific region of a movement path of the first coupling portion 5. For example, the dampening mechanism 7 may be configured such that a resistance against the movement of the first coupling portion 5 is only provided close to the extended position of the first coupling portion 5. In other words, a configuration may be provided in which in a first region of the movement path of the first coupling portion 5, for example in a movement from the retracted position to a predetermined intermediate position of the first coupling portion 5, no resistance is provided. Accordingly, the lid 12 may be initially movable from the closed configuration towards the opened configuration for a predetermined distance without any influence exerted on the movement by the dampening mechanism 7.

The dampening mechanism 7 may comprise a linear damper and/or a rotary damper. Furthermore, in some embodiments, the resistance exerted by the dampening mechanism may be adjustable. In some embodiments, the dampening mechanism may be configured to provide a continuous dampening. Accordingly, the dampening mechanism 7 may be continuously operatively coupled to the first coupling portion 5 and to the movable portion 3 and may, thus, remain connected with the movable portion 3 at all times. Accordingly, in some embodiments, the movable portion 3 may not be movable without actuating the dampening mechanism 7. The movable portion 3 may thus be under continuous influence of the damping mechanism 7 and may not move independent of the dampening mechanism 7. In some configurations, dampening may also be provided such that a movement speed of the movable portion 3 is maintained substantially constant by the dampening mechanism.

Further details regarding a possible configuration of the tilting mechanism 4 will be described with reference to FIGS. 2 and 3 in the following. FIG. 2 shows the tilting mechanism 4 in a retracted configuration in FIG. 3 shows the tilting mechanism 4 of FIG. 2 in an extended or deployed configuration. As is shown in FIGS. 2 and 3, the tilting mechanism 4 comprises the already described first coupling portion 5, the second coupling portion 6 and the dampening mechanism 7.

The tilting mechanism 4 may be configured as a lid lifter. In particular, the tilting mechanism 4 according to some embodiments is configured as a hinge mechanism. Therefore, in the following, a basic construction of such a hinge mechanism which may be provided in all of these embodiments will be described first. Later, focus of the description will be put on differences between the different configurations.

Embodiments in which the tilting mechanism 4 comprises a hinge mechanism are shown in FIGS. 2 to 14. Each of the tilting mechanisms 4 comprises a hinge mechanism 100, 200, 300, 400, 500, 600, 700, 800. Each of the hinge mechanisms 100, 200, 300, 400, 500, 600, 700, 800 comprises a first link member 101, 201, 301, 401, 501, 601, 701, 801 and a second link member 102, 202, 302, 402, 502, 602, 702, 802 coupled to each other pivotable about a pivot axis P. The second link member 102, 202, 302, 402, 502, 602, 702, 802 is movable relative to the first link member 101, 201, 301, 401, 501, 601, 701, 801 between a retracted position and an extended position. The first coupling portion 5 is provided on the second link member 102, 202, 302, 402, 502, 602, 702, 802 and the second coupling portion 6 is provided on the first link member 101, 201, 301, 401, 501, 601, 701, 801.

Each first link member 101, 201, 301, 401, 501, 601, 701, 801 comprises a first end portion 103, 203, 303, 403, 503, 603, 703, 803 and a second end portion 104, 204, 304, 404, 504, 604, 704, 804. The second coupling portion 6 is defined in each first end portion 103, 203, 303, 403, 503, 603, 703, 803 of the first link member 101, 201, 301, 401, 501, 601, 701, 801. For that, an opening 108, 208, 308, 408, 508, 608, 708, 808 is provided in the first end portion 103, 203, 303, 403, 503, 603, 703, 803. Each first link member is pivotably coupled to a stationary portion 2 by means of a suitable fixation member which is inserted in the opening 108, 208, 308, 408, 508, 608, 708, 808. Each second end portion 104, 204, 304, 404, 504, 604, 704, 804 is configured to be coupled to the second link member.

Each second link member 102, 202, 302, 402, 502, 602, 702, 802 comprises a first end portion 105, 205, 305, 405, 505, 605, 705, 805 at which the first coupling portion 5 is defined, for example by means of openings 113, 213, 313, 413, 513, 613, 713. Each second link member is pivotably coupled to the movable portion 3 by means of a suitable fixation member which is inserted in the respective opening and coupled to the movable portion 3. Furthermore, each second link member 102, 202, 302, 402, 502, 602, 702, 802 comprises a second end portion 106, 206, 306, 406, 506, 606, 706, 806 which is configured to be pivotably coupled to the first link member. The coupling between the first link member and the second link member may be provided by means of a pivot pin 109, 209, 509, 609, 709, for instance, wherein each pivot pin may define the pivot axis P. Each second link member 102, 202, 302, 402, 502, 602, 702, 802 may comprise a solid arm 110, 210, 310, 410, 510, 610, 710, 810 which may be formed by molding, for example by molding a plastics material. Each first link member 101, 201, 301, 401, 501, 601, 701, 801 may comprise a housing portion 107, 207, 307, 407, 507, 607, 707, 807. The housing portion may be configured to at least partially accommodate a second end portion of the second link member. For that, the housing may be configured with a fork like end portion of having two prongs between which the second end portion of the second link member may be accommodated.

In some embodiments, the dampening mechanism 7 may be coupled to the first link member at a first coupling section 111 and to the second link member 102 at a second coupling section 112. The first coupling section 111 may be provided on the housing portion 107. The dampening mechanism 7 may be provided on an outer portion of the hinge mechanism 100. The dampening mechanism 7 may be provided as a separate unit which is arranged exterior to the hinge mechanism 100 and is coupled to outer portions of the hinge mechanism 100. Such a configuration allows retrofitting a dampening mechanism 7 with existing hinge mechanisms such as lid lifters to provide a lifting mechanism according to the present disclosure. On the other hand, it is also possible to integrate a dampening mechanism 7 into a hinge mechanism.

The dampening mechanism 7 may be configured as a frictional damper, a viscous damper, or as a pneumatic cylinder, for example a vacuum chamber with a piston.

The dampening mechanism may comprise a linear damper 80, for example a dashpot (not shown) or a pneumatic cylinder as shown in FIGS. 15 and 16. The linear damper 80 comprises a cylindrical portion 81 in which a piston 82 is linearly movably arranged. The cylindrical portion 81 comprises a first end portion 83 and a second end portion 84. An opening for receiving the piston 82 is provided in the first end portion. The second end portion 84 comprises a wall 89 limiting an interior space of the cylindrical portion 81 at the second end portion 84. An opening 88 is provided in the wall 89. The dimension of the opening may be changeable for adjusting a resistance of the linear damper 80. Accordingly, an outside of the linear damper 80 is fluidly coupled to an interior space of the cylindrical portion 81. In particular, air is able to pass through the opening 88. The piston 82 comprises a first end portion 85 comprising a fixation opening 86. Although a fixation opening 86 is shown, the first end portion 85 may be configured differently and may comprise another configuration allowing a fixation of the first end portion 85. A second end portion 87 of the piston 82 is slidably received in the cylindrical portion 81. Accordingly, a movement of the piston towards and away from the wall 89 leads to a compression of air inside the cylindrical portion 81 or creates a negative pressure within the cylindrical portion 81. Consequently, the piston 82 resists a movement in both directions. In a modification, the configuration can be such that the piston 82 only resists a movement in one direction. Such a configuration may be achieved by providing a suitable valve arrangement in which passing of air in one direction is easily possible and limited in the other direction. Although not shown, the second end portion 84 may be configured to be fixedly coupled to the second coupling portion 6. For example, in an embodiment, the second end portion 84 may be configured to be coupled to the first coupling section 111 of the first link member 101. The first end portion 85 may be configured to be coupled to the first coupling portion 5. For example, in an embodiment, the first end portion 85 may be configured to be coupled to the second coupling portion 112 of the second link member 102. An inverted arrangement is however also possible.

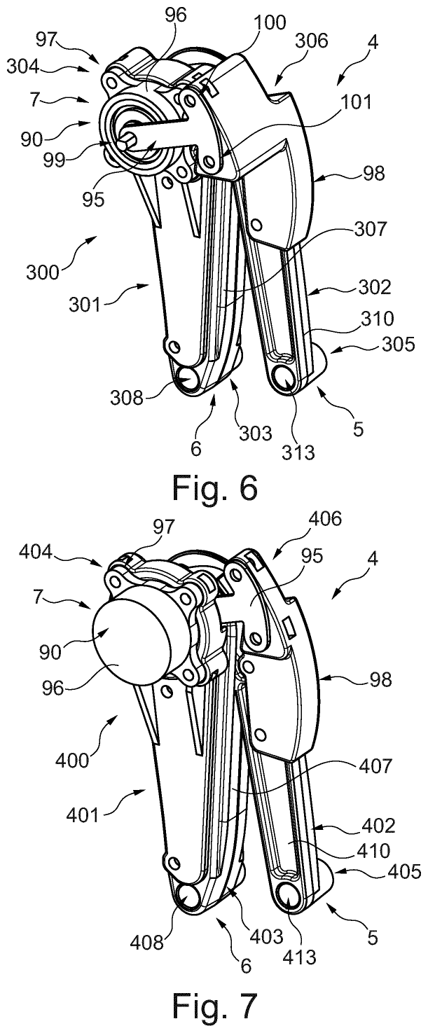

In addition or alternatively, the dampening mechanism may comprise a rotary damper 90. The rotary damper 90 may be a frictional damper or a viscous damper. Embodiments in which a rotary damper 90 is used are shown in FIGS. 6 to 13.

The rotary damper 90 may comprise a fixed portion such as a housing 96. The housing 96 may be configured so as to be operatively coupled to the second coupling portion 6. In some embodiments, the housing 96 is configured to be fixedly coupled to the first link member 301, 401, 501, 701. For that, the housing 96 may comprise a flange 97 as shown for example in FIGS. 6 and 7.

Furthermore, the rotary damper 90 may comprise a rotary shaft 99 which is operatively coupled to the housing 96 such that it resists a movement, for example frictionally coupled or coupled via a viscous fluid. The rotary shaft may be a rotary piston which is in fluid connection with a viscous fluid inside the housing 96. In particular, a first end portion of the rotary piston may be in fluid connection with the viscous fluid and an opposite second end portion may comprise a fixation section. The second end portion of the rotary shaft 29 is operatively coupled to the first coupling portion 5. Although not shown in the embodiments, the second end portion of the rotary shaft 99 may form a pivot pin of the hinge mechanisms as described before and may for example define the pivot pin 109 as shown in FIG. 3. In such a configuration, the second link member 102 may be directly supported on the rotary shaft 99. Alternatively, the second end portion of the rotary shaft 99 may be operatively coupled to the first coupling section 5 by means of a force transfer member 95. The force transfer member 95 may comprise a T shape as is shown in FIG. 6. In the force transfer member 95 may be coupled to the rotary shaft 99 at a first end portion thereof and may be coupled to the first coupling portion 5 by means of fixation sections 100, 101 thereof. The fixation sections may be coupled to a coupling portion 98 which is operatively coupled to the first coupling portion 5, for example by being fixed to a second link member of the before described link members, for example the second link member 302. In the configuration as shown in FIG. 6, the housing 96 of the rotary damper 90 is arranged between the force transfer member and the first link member 301. However, as is shown in FIG. 7, an arrangement may be provided in which the rotary damper 90 is inversely arranged so that the force transfer member 95 is arranged between the housing 96 and the first link member 401.

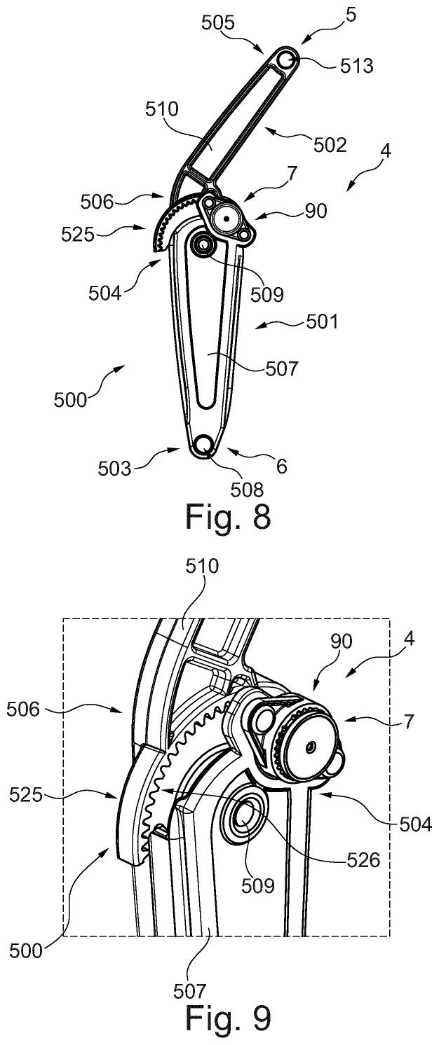

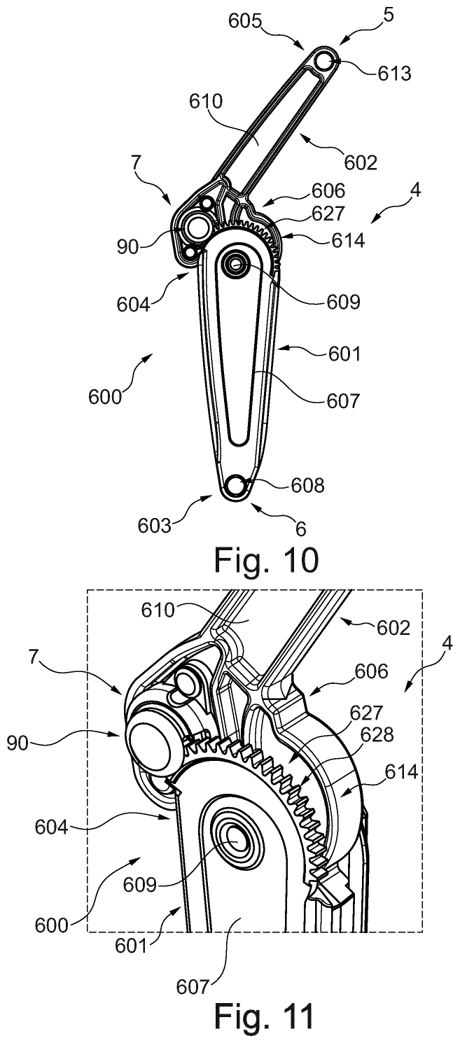

Instead of the force transfer member 95 as shown in FIG. 6, the rotary shaft 99 may be operatively coupled by means of a gear mechanism. FIG. 8 shows an embodiment in which the housing of the rotary damper is fixed on a second end portion 504 of the first link member 501. Although not shown in FIG. 8, a gear is fixedly coupled on the rotary shaft 99. The toothed portion 525 comprising teeth 526, is provided on the second end portion 506 of the second link member 502. The gear is engaged with the toothed portion 525. The toothed portion 525 comprises the shape of a segment of the circle which extends about the pivot axis P and the pivot pin 509. Accordingly, the rotary shaft 99 may be arranged in parallel with the pivot pin 509 so that an extension direction of the rotary shaft 99 is in parallel with the pivot axis P. An inverse arrangement is shown in FIGS. 10 and 11. In this configuration, the rotary damper 90 is provided on the second end portion 606 of the second link member 602. A toothed portion 627 comprising teeth 628 is provided on the second end portion 604 of the first link member 601. For example, the toothed portion 627 may be integrally formed in the housing, for example in the above-described fork like end portion, more precisely in a free end of one of the two prongs between which the second end portion of the second link member may be accommodated. Again, the rotary shaft 99 is in engagement with the toothed portion 627 by means of a gear (not shown) which is in engagement with the toothed portion 627.

In some embodiments, the housing portion may be configured to support and/or accommodate an urging mechanism. In some embodiments, the housing portion may be configured of to accommodate the dampening mechanism. In some configurations, the housing portion may be configured to accommodate an urging mechanism and a dampening mechanism.

The urging mechanism may be configured to apply an urging force, for example on the second link member, for example on a force receiving surface 114, 214, 614, 714, 814 provided on the second link member. The force receiving surface may be configured as a cam surface. The urging mechanism may be configured such that the force application member is in sliding contact with the force receiving surface. Other configurations for applying an urging force on the second link member are also possible. For example, a portion of the urging mechanism may be pivotably coupled to the second link member instead of being in sliding contact with the force receiving surface. The urging mechanism may be configured to at least apply an urging force on the second link member urging the second link member in an extension direction. Such an urging mechanism may assist the user in opening the lid. Furthermore, such an urging mechanism may ensure that the lid remains in an opened configuration. In a modification, the urging mechanism may be configured such that an urging force is provided in extension direction and retraction direction. For that, the cam surface may be specifically shaped, and the force application member configured such that a moment created on the second link member by the force applied on the force receiving surface is reversed as soon as the second link member passes a predetermined intermediate position. In this way, an assisting force may be created in both movement directions of the second link member.

The dampening mechanism may be configured such that it at least provides a resistance when an urging force is applied on the second link member. In other words, an urging force and a resistance on the second link member may be simultaneously applied in order to provide a controlled movement of the second link member.

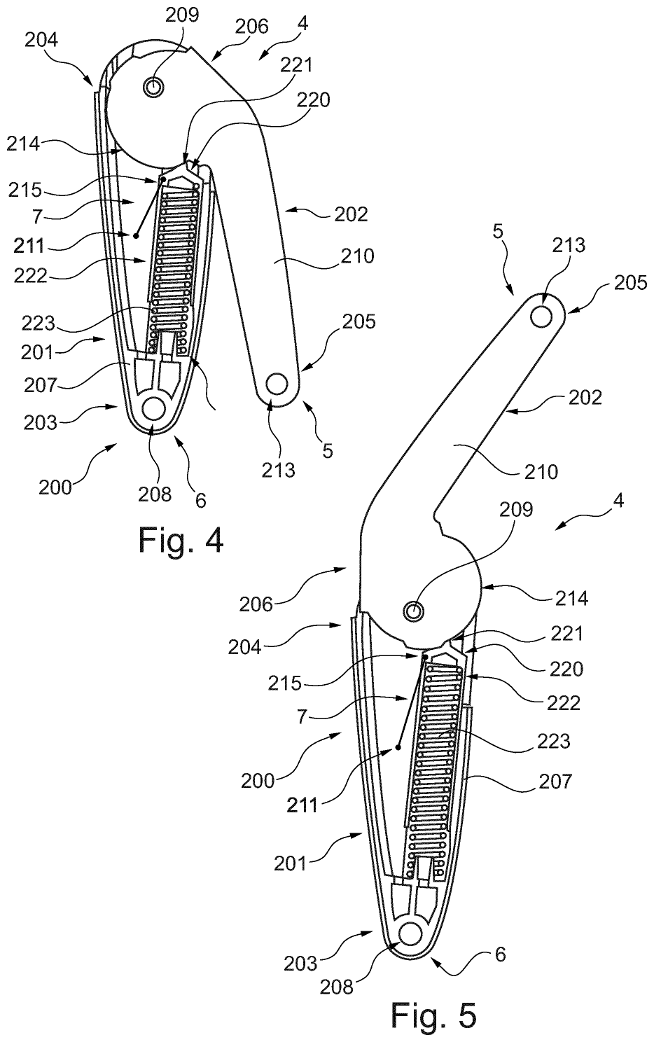

A possible configuration of the force application members 220, 720, 820 is shown in FIGS. 4, 5, 13 and 14. The force application members are accommodated in the first link member 201, 701, 801. The force application member 220, 720, 820 may comprise a force application portion 221, 721, 821 which is configured to be in sliding contact with the force receiving surfaces 214, 714, 814 and configured to apply in urging force on these surfaces. The force application members 220, 720, 820 are prebiased towards the force receiving surfaces by an urging member or biasing member, for example a spring 223, 723, 823. Each force application member 220, 720, 820 may comprise an accommodating section 222, 722, 822 which may be formed as a hollow cylindrical portion. The accommodating section is configured to receive at least a portion of the urging member or biasing member. An opposite end of the urging or biasing member may be supported in the first end portion 201, 701, 801. Furthermore, the accommodating section may serve as a guiding section which is in sliding contact with the housing portion 207, 707, 807. Accordingly, the force application members are configured to continuously apply an urging force on the receiving surfaces.

In some embodiments, the dampening mechanism 7 may be configured to be operatively connected to the force application members 220, 720, 820. In other words, the dampening mechanisms 7 may be configured to influence a movement of the force application members 220, 720, 820.

For example, in the configuration as shown in FIGS. 4 and 5, the dampening mechanism 7 may be operatively coupled to the force application member 220 at a first coupling section 215 and may be coupled to the housing 207, more precisely an interior portion of the housing 207, at a second coupling section 211. Accordingly, a resistance force may be applied on the force application member 220 such that a movement speed of the same towards the force receiving section is controlled. In this configuration, the dampening mechanism 7 may be a linear damping mechanism, for example a dashpot.

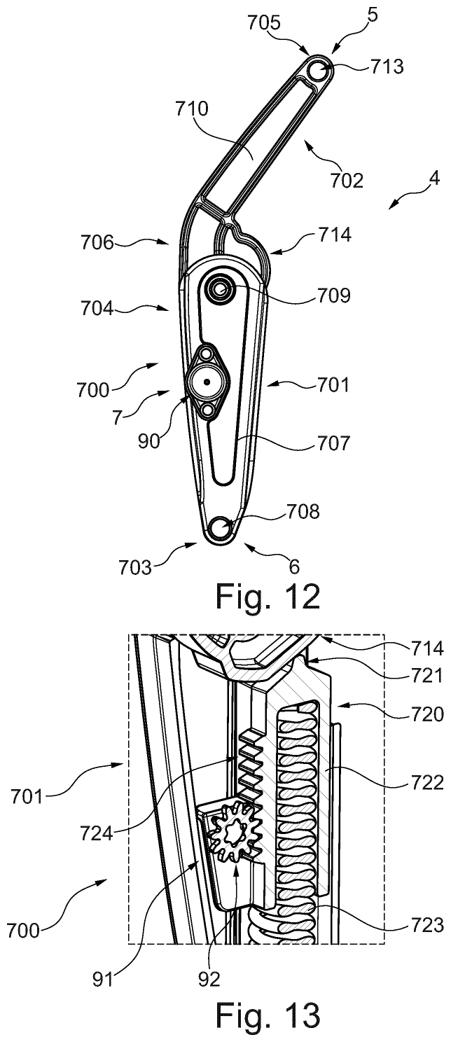

In a further configuration as shown in FIG. 13, a rotary damper 90 may be operatively coupled to the force application member 720 by means of a gear mechanism 91. The gear mechanism 91 comprises a gear or cog 92 which is fixedly coupled to a rotary shaft of the rotary damper 90. A toothed portion 724 is provided on the force application portion 720, for example on an outer surface of accommodating section 722. As is shown in FIG. 12, the rotary damper 19 may be provided in a middle section of the first link member 701. Again, a configuration is achieved in which a movement speed of the force application member 720 is controlled by a dampening mechanism 7.

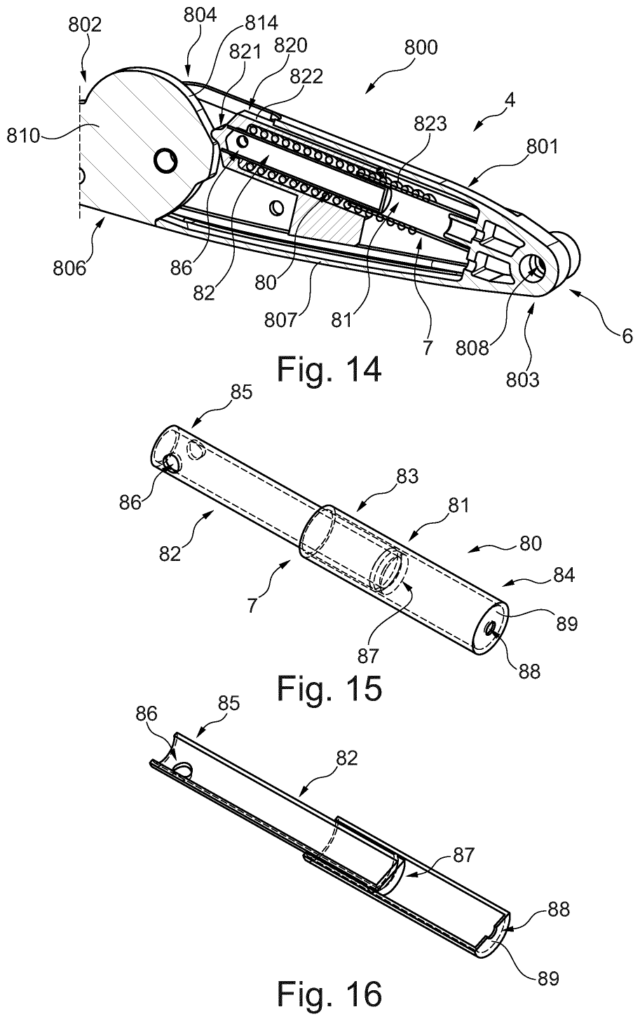

FIG. 14 shows an embodiment in which a linear damper 80 is integrated into the force application member 820. As is shown, the linear damper 18 may be configured as already described with respect to FIGS. 15 and 16. The piston 82 is coupled to the force application member 820 using the fixation opening 86. The second end portion 84 of the linear damper 80 is fixedly supported in the first end portion 803 of the first link member 801. As is also shown, the spring 823 is provided on the linear damper 80. Accordingly, the linear damper 80 may serve as a guiding portion or support for the spring 823. Furthermore, the piston 82 is at least partially accommodated in the accommodating section 822. Again, a configuration is achieved in which a movement speed of the force application member 820 is controlled by a dampening mechanism 7.

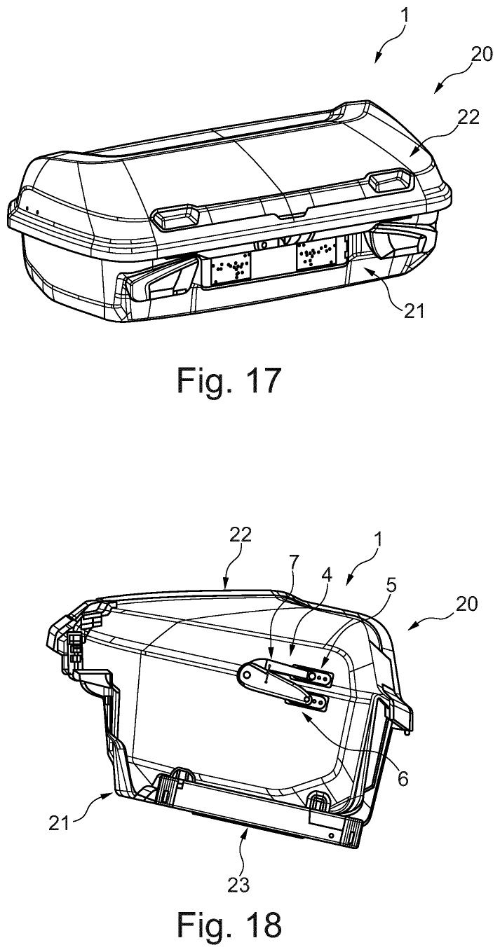

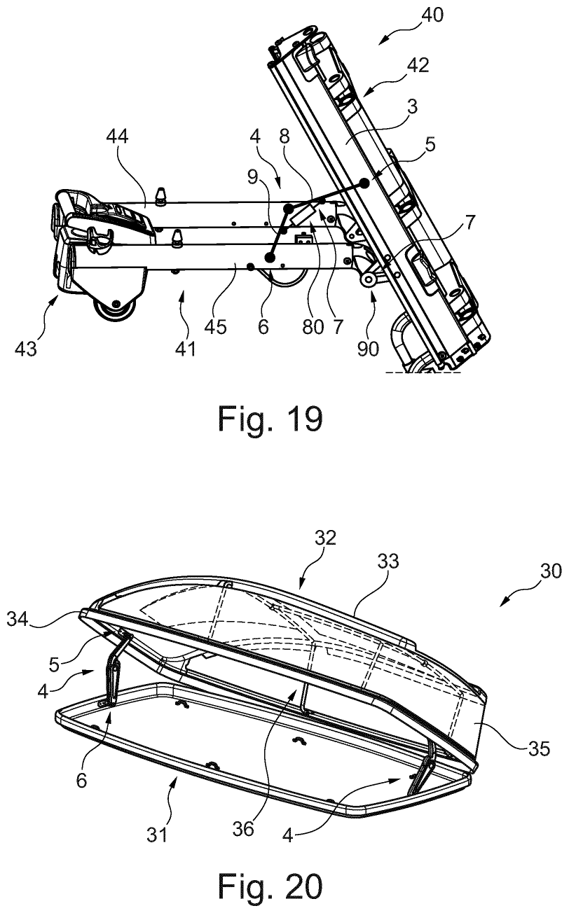

The tilting mechanism 4 may be used in various kinds of load carriers 1. For example, the tilting mechanism 4 may be provided in a cargo box mountable to the rear of the vehicle as shown in FIGS. 17 and 18. Such a rear box 20 is shown in FIG. 17 and may comprise a base portion 21 for supporting goods to be transported and an openable and closable lid 22 which is pivotably mounted to the base portion 21. The first coupling portion 5 is coupled to the lid 22 and the second coupling portion 6 is coupled to the base portion 21. The base portion may comprise a coupling section 23 for mounting the rear box 20 on a supporting frame which is coupled to our couplable to the rear of a vehicle.

Furthermore, the tilting mechanism 4 may be used on load carriers 40 comprising a pivotable support platform 42 as movable portion 3 which is pivotably mounted to a base 41, for example a frame structure comprising frame members 44, 45. The base 41 may be couplable to a vehicle by means of a coupling portion 43 which may be configured to be engaged with a hitch or fix point structure provided on the vehicle. The load carrier 40 may be a bike carrier. In such a configuration, the pivotable support platform 42 may be configured to support bikes thereon. The support platform 42 may be coupled to the base 41 by means of the tilting mechanism 4 as described before. In particular, the tilting mechanism 4 may comprise a linear damper 80 as described before. The tilting mechanism 4 may be coupled to the base 41 at a second coupling portion 6 and may be coupled to the movable portion 3 via the first coupling portion 5 thereof. The tilting mechanism 4 may comprise a hinge mechanism as described before. The tilting mechanism 4 may alternatively only comprise a rotary damper 90 which couples the movable portion 3 to the base 41. For example, a rotary shaft of the rotary damper 90 may be coupled to the base 41 and a housing of the rotary damper 90 may be coupled to the movable portion 3. Accordingly, a load carrier, in particular bike carrier, with a movable platform and an integrated rotary damper 90 may be provided.

The tilting mechanism 4 as described above may also be used in a collapsible cargo box as is shown in FIG. 20. The cargo box is configured as a roof box 30 and comprises a base portion 31 and an openable and closable lid 32. The lid 32 comprises a first lid portion 33 and a second lid portion 34 which are hingedly coupled at a front portion of the lid 32. The first lid portion 33 is movable between a deployed configuration as shown in FIG. 20 and a retracted configuration in which the first lid portion 33 is moved towards the second lid portion 34. A flexible material 35 such as a fabric is coupled to edge portions of the first lid portion 33 and the second lid portion 34. The flexible material 35 creates a sidewall of the lid 32 when the same is in deployed configuration as shown in FIG. 20. The lid 32 comprises an operating mechanism 36 which is configured to transfer the first lid portion 33 between the retracted configuration and the deployed configuration. The tilting mechanism as described before may be configured to couple the base portion 31 with the lid 32, in particular with the second lid portion 34. The first coupling portion 5 is pivotably coupled to the lid 32 and the second coupling portion 6 is pivotably coupled to the base portion 31.

1-13. (canceled)

14. A tilting mechanism for a load carrier, the tilting mechanism configured to assist a tilting movement of a movable portion of the load carrier into a non-use position, the tilting mechanism comprising:
a first coupling portion configured to be coupled to the movable portion of the load carrier and movable between a retracted position and an extended position; and
a damping mechanism configured to at least partially decelerate or limit a movement speed of the first coupling portion upon moving the same to the extended position.

15. The tilting mechanism of claim 14, further comprising a second coupling portion configured to be coupled to a stationary portion of the load carrier and operatively coupled to the first coupling portion by an operative coupling,
wherein the first coupling portion is movable with respect to the second coupling portion along a path having a translatory directional component or a rotatory directional component.

16. The tilting mechanism of claim 15, wherein the dampening mechanism is configured to act on the operative coupling between the first coupling portion and the second coupling portion, and
wherein the dampening mechanism provides a resistance against the movement of the first coupling portion with respect to the second coupling portion during the movement of the first coupling portion in an extension direction.

17. The tilting mechanism of claim 15, further comprising an urging mechanism,
wherein the urging mechanism acts on the operative coupling between the first coupling portion and the second coupling portion such that it at least partially applies a force which urges the first coupling portion with respect to the second coupling portion at least in an extension direction of the first coupling portion.

18. The tilting mechanism of claim 17, wherein the dampening mechanism is operatively coupled to the force application member and configured to at least partially decelerate or limit a movement speed of the force application member.

19. The tilting mechanism of claim 15, further comprising a hinge mechanism defining the operative coupling, the hinge mechanism comprising a first link member coupled to a second link member,
wherein the first link member and the second link member are pivotable about a pivot axis,
wherein the second link member is movable relative to the first link member between a retracted position and an extended position, and
wherein the first coupling portion is provided on the second link member and the second coupling portion is provided on the first link member.

20. The tilting mechanism of claim 19, wherein the damping mechanism is operatively coupled to the first link member and the second link member.

21. The tilting mechanism of claim 20, wherein the damping mechanism comprises a linear damper operatively coupled to the first link member at a first coupling section of the first link member and operatively coupled to the second link member at a second coupling section of the second link member.

22. The tilting mechanism of claim 20, wherein the damping mechanism comprises:
a rotary damper having a housing operatively coupled to one of the first link member or the second link member; and
a rotary shaft operatively coupled to the other one of the second link member and the first link member.

23. A lid lifter for a load carrier, the lid lifter configured to couple a lid of the load carrier to a base portion of the load carrier, the lid lifter comprising:
a tilting mechanism configured to assist a tilting movement of the lid into a non-use position, the tilting mechanism comprising:
a first coupling portion pivotably couplable to the lid of the load carrier and movable between a retracted position and an extended position, and
a damping mechanism configured to at least partially decelerate or limit a movement speed of the first coupling portion upon moving the same to the extended position.

24. A cargo box mountable on a vehicle, the cargo box comprising:
a base portion configured to support goods to be transported;
an openable and closeable lid pivotably mounted on the base portion; and
the lid lifter of claim 23, wherein the lid lifter is coupled to the lid by the first coupling portion and coupled to the base portion by the second coupling portion.

25. The cargo box of claim 24, wherein the cargo box is configured to be collapsible.

26. A load carrier for a vehicle comprising:
a base configured to be coupled to the vehicle;
a movable portion pivotably coupled to the base, wherein the movable portion is movable between a use configuration in which the movable portion is folded onto the base and a non-use configuration which the movable portion is tilted with respect to the base; and
the tilting mechanism of claim 14, wherein the first coupling portion is coupled to the movable portion.
